(19) United States
(12) Patent Application Publication
(10) Pub. No.: US 2013/0331132 A1
(43) Pub. Date: Dec. 12, 2013

(54) MOBILE DEVICE AND METHOD FOR CONTROLLING MESSAGING

(71) Applicant: Samsung Electronics Co., Ltd., Gyeonggi-do (KR)

(72) Inventors: Marcin GOLISZEWSKI, Warsaw (PL); Maciej Marek LIPINSKI, Warsaw (PL)

(21) Appl. No.: 13/914,190

(22) Filed: Jun. 10, 2013

(30) Foreign Application Priority Data
Jun. 8, 2012 (KR) 10-2012-0061648

(51) Int. Cl. H04W 4/12

(52) U.S. Cl. CPC H04W 4/12
USPC 455/466

(57) ABSTRACT

A mobile device and method are provided for controlling messaging. The method includes receiving a send request for a message from a user; analyzing a writing style of content of the message; comparing the writing style with a user behavior pattern that is pre-set for a standard writing style of the user to determine whether a non-standard writing style is detected; and withholding sending the message, upon detecting the non-standard writing style.

### PRIORITY

This application claims priority under 35 U.S.C. §119(a) to Korean Patent Application Serial No. 10-2012-0061648, which was filed in the Korean Intellectual Property Office on Jun. 8, 2012, the entire disclosure of which is incorporated herein by reference.

### BACKGROUND OF THE INVENTION

1. Field of the Invention

The present invention relates generally to a method and apparatus for controlling the sending of messages in a mobile device, and more particularly, to a mobile device and method for controlling whether to send messages.

2. Description of the Related Art

Mobile devices provide message services such as Short Message Service (SMS), Multimedia Message Service (MMS), and e-mail. In some cases, a user of a mobile device may send message while in a very emotional state, i.e., when the user is unable to think logically, e.g., when drunk or extremely angry. Herein, a state in which the user cannot think logically will be referred to as a “bad state of mind,” while the opposite state where the user can think logically will be referred to as a “good state of mind.” In addition, a message sent while in the bad state of mind will be referred to as a “regrettable message.”

Some solutions to so-called drunk dialing/texting have been proposed.

For example, there is a solution centralized on mobile operators, i.e., service provider, where selected mobile numbers are rerouted as dead numbers by the mobile operator, for a predetermined period of time. However, a user may take advantage of this solution only when the user's mobile operator provides this service, because the solution is dependent on the mobile operator. In addition, this service usually requires an additional fee.

Another example is a password-based solution, wherein when drunk dialing/texting prevention is enabled in a mobile device, a user of the mobile device should enter a password in order to dial/text. However, users often forget to enable the drunk dialing/texting prevention, or users may not be able to call/text, even in a good state of mind, if they forget their passwords.

Another example disables the possibility of calling/texting a selected phone number for a predetermined period of time. However, this solution is neither intelligent nor adaptive, because the user is prevented from calling/texting even in a good state of mind.

Another example uses questions, wherein when the drunk dialing/texting prevention is enabled, a user must answer a question or solve a problem, e.g., a math problem, within a predetermined time in order to be allowed to send messages. However, the user may be prevented from sending e-messages even in the good state of mind, if the user forgets the answer to the question or cannot solve the problem.

The above-described solutions are often inconvenient and dependent on mobile operators, and therefore, are likely to not be used or cause false prevention that is unwanted or unintended by users.

### SUMMARY OF THE INVENTION

The present invention is designed to address at least the above-described problems and/or disadvantages, and to provide at least the advantages described below.

An aspect of the present invention is to provide a mobile device and a messaging control method that increases a possibility of preventing a regrettable message and decreases false prevention.

Another aspect of the present invention is to provide a mobile device and a messaging control method that adaptively controls whether or not to send messages depending on a user's state of mind.

Another aspect of the present invention is to provide a mobile device and a messaging control method that controls whether or not to send messages based on message content.

Another aspect of the present invention is to provide a mobile device and a messaging control method that controls whether or not to send messages based on an analysis of message content and user behavior.

In accordance with an aspect of the present invention, a method is provided for controlling messaging in a mobile device. The method includes receiving a send request for a message from a user; analyzing a writing style of content of the message; comparing the writing style with a user behavior pattern that is pre-set for a standard writing style of the user to determine whether a non-standard writing style is detected; and withholding sending the message, upon detecting the non-standard writing style.

In accordance with another aspect of the present invention, a method is provided for controlling messaging in a mobile device. The method includes collecting writing manner data associated with a user writing a message; receiving a send request for the message from the user; analyzing a writing manner from the writing manner data; comparing the writing manner with a user behavior pattern that is pre-set for a standard writing manner of the user to determine whether a non-standard writing manner is detected; and withholding sending of the message, upon detecting the non-standard writing manner.

In accordance with another aspect of the present invention, a method is provided for controlling messaging in a mobile device. The method includes collecting writing manner data associated with a user writing a message; receiving a send request for the message from the user; analyzing a writing style of content of the message; analyzing a writing manner from the writing manner data; comparing the writing style and the writing manner with a user behavior pattern pre-set for a standard writing style and a standard writing manner of the user to determine whether a non-standard writing style or a non-standard writing manner is detected; and withholding sending of the message, upon detecting the non-standard writing style or the non-standard writing manner.

In accordance with another aspect of the present invention, a mobile device is providing that controls messaging. The mobile device includes a user interface; a database that stores a user behavior pattern that is pre-set for a standard writing style of a user; and a controller that receives a send request for a message from the user through the user interface, analyzes a writing style of content of the message, compares the writing style with the user behavior pattern, and withholds sending the message, upon detecting a non-standard writing style.

In accordance with another aspect of the present invention, a mobile device is provided that controls messaging. The mobile device includes a user interface; a database that stores a user behavior pattern that is pre-set for a standard writing manner of a user; and a controller that detects the user writing a message on the user interface, collects writing manner data associated with the user writing the message, and upon receiving a send request for the message from the user, analyzes a writing manner from the writing manner data, compares the writing manner with the user behavior pattern, and withholds sending the message, upon detecting a non-standard writing manner.

In accordance with another aspect of the present invention, a mobile device is provided that controls messaging. The mobile device includes a user interface; a database that stores a user behavior pattern that is pre-set for a standard writing style and a standard writing manner of a user; and a controller that detects when the user starts writing a message on the user interface, collects writing manner data associated with the message writing, and upon receiving a send request for the message from the user, analyzes a writing style of content of the message, analyzes a writing manner from the writing manner data, compares the writing style and the writing manner with the user behavior pattern, and withholds sending the message, upon detecting a non-standard writing style or a non-standard writing manner.

### BRIEF DESCRIPTION OF THE DRAWINGS

The above and other aspects, features, and advantages of certain embodiments of the present invention will be more apparent from the following description when taken in conjunction with the accompanying drawings, in which:

FIG. 1 is a block diagram illustrating a mobile device according to an embodiment of the present invention;

FIGS. 2A and 2B are flowcharts illustrating a method for controlling messaging according to an embodiment of the present invention; and

FIG. 3 is a flowchart illustrating a method of learning a user behavior pattern according to an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

Although embodiments of the present invention will be described below with reference to a mobile device, by way of example, the embodiments of the present invention may also be applied to other devices having similar technical backgrounds. For example, the embodiments of the present invention may be similarly applied to other electronic devices that provide message services, e.g., desktop computers.

A mobile device, as described herein, may be any one of a mobile phone, a smart phone, a laptop computer, and a tablet computer; all of which can provide message services.

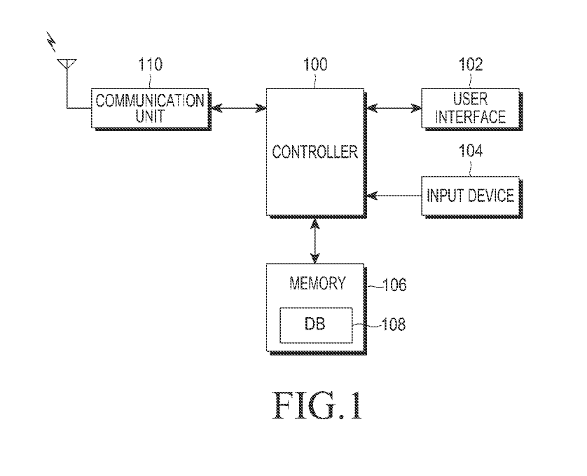

FIG. 1 is a block diagram illustrating a mobile device according to an embodiment of the present invention.

Referring to FIG. 1, the mobile device includes a controller 100, a user interface 102, an input device 104, a memory 106, and a communication unit 110. The user interface 102, the input device 104, the memory 106 and the communication unit 110 are connected to the controller 100.

The user interface 102 provides an input interface and an output interface between the mobile device and a user. For example, the user interface 102 may include input/output devices such as a microphone, a speaker, a keypad, buttons, a display, a touch screen display, etc. The user interface 102 provides user inputs received through input devices to the controller 100, and provides outputs, e.g., audio and video generated by an operation of the controller 100, to the user through output devices.

The input device 104 is used to detect emotional and/or physiological states of a user, and provides signals indicating emotional/physiological states of the user to the controller 100. The expression “emotional/physiological” as used herein refers to “emotional and/or physiological.”

An example of the input device 104 is disclosed in U.S. Pat. No. 7,874,983 B2, entitled “Determination of Emotional and Physiological States of a Recipient of a Communication,” to William Zancho et al., and issued on Jan. 25, 2011, hereinafter referred to as Zancho.

Zancho discloses technology for determining emotional and physiological states of a communication device user. Specifically, referring to column 3, line 55 to column 4, line 32 of Zancho, a recipient communication device includes an input device used to detect emotional and/or physiological states of a user of a device. The input device may include one or more of a biosensor, an environmental monitor, a voice analyzer, a pressure sensor, an optical analyzer, a download of a workload schedule of the user, and any other ways to convey an emotional or physiological state of a user. Accordingly, the input device provides a signal indicative of one of an emotional and a physiological state of a user of the device. A controller interprets the signal into state data identifying one of an emotional and a physiological state of a user of the device, and stores the state data in a buffer. The controller maps the input device signal to a table in which input device signals correspond to emotional and physiological state data, to identify the emotional or physiological state corresponding to the input device signal.

Referring again to FIG. 1, the memory 106 stores a program or programs executed by the controller 100, and stores data generated by the execution of the programs by the controller 100. The memory 106 includes a DataBase (DB) 108. The DB 108 stores a pre-set or established user behavior pattern to which the controller 100 will make reference to in order to control messaging. The memory 106 may further include an external memory and a storage device such as a Hard Disk Drive (HDD).

The communication unit 110 transmits and receives radio signals for mobile communication services performed by the controller 100. The mobile communication services include message services such as SMS, MMS and e-mail. In addition to the communication unit 110, the mobile device may further include other communication devices, for example, wired/wireless communication devices such as a Universal Serial Bus (USB), a Local Area Network (LAN) device, and Bluetooth device.

The controller 100 controls common operations of the mobile device. The controller 100 controls the sending of messages based on an analysis of message content and a user behavior. The analysis of message content and a user behavior refers to analyzing a user's writing style for content of a message written by the user, a user's writing manner for the message, and a user's emotional/physiological state.

The user's writing style may include syntactical structures, a frequency of errors, length of messages, usage/non-usage of proper grammar, usage of abbreviations, and words expressing negative emotions. The controller 100 identifies the writing style by analyzing the message content written by the user.

The writing manner may include a speed of writing, and a frequency of making mistakes. The controller 100 identifies the writing manner by collecting and analyzing writing manner data generated based on the user's message writing.

Additionally, the controller 100 analyzes the user's emotional/physiological state. If the user's emotional/physiological state corresponds to a non-standard state, the controller 100 analyzes the writing style and the writing manner, and compares the analyzed writing style and writing manner with the user behavior pattern set in advance and stored in the DB 108 to determine whether a non-standard writing style and/or a non-standard writing manner are detected. The term “non-standard state” as used herein refers to an abnormal state that deviates from a standard state by a predetermined range or more, and the terms “non-standard writing style” and “non-standard writing manner” as used herein refer to an abnormal writing style and an abnormal writing manner that deviate from a standard writing style and a standard writing manner by a predetermined range or more, respectively.

The user behavior pattern is set in advance regarding the standard writing style and the standard writing manner, and stored in the DB 108. For example, the user behavior pattern may be set as a statistical behavior pattern that is analyzed for general users. As for the writing manner, for example, a writing speed and a frequency of making mistakes in a normal state may be analyzed for each of a predetermined number of users taken as samples, and among them, the typical writing speed and the typical frequency of making mistakes may be set in a user behavior pattern. The user behavior pattern may be set by a manufacturer of the mobile device or by a mobile operator, and stored in the DB 108.

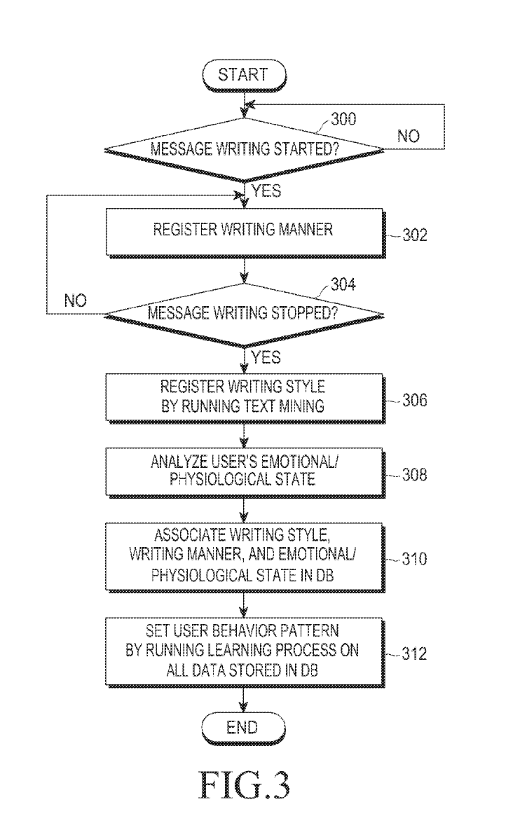

Alternatively, the controller 100 may learn a user behavior pattern associated with a specific user of the mobile device, to set a user behavior pattern of the mobile device, and then store the user behavior pattern in the DB 108. A method of learning the user behavior pattern associated with a user of the mobile device will be described in more detail below with reference to FIG. 3.

Upon receiving a send message request from the user, the controller 100 withholds sending of the message, if the user's emotional/physiological state corresponds to a non-standard state, and a non-standard writing style and/or a non-standard writing manner are detected. Thereafter, if the user's emotional/physiological state changes to the standard state, the controller 100 sends the withheld message, upon receiving a response indicating an intention to send the message.

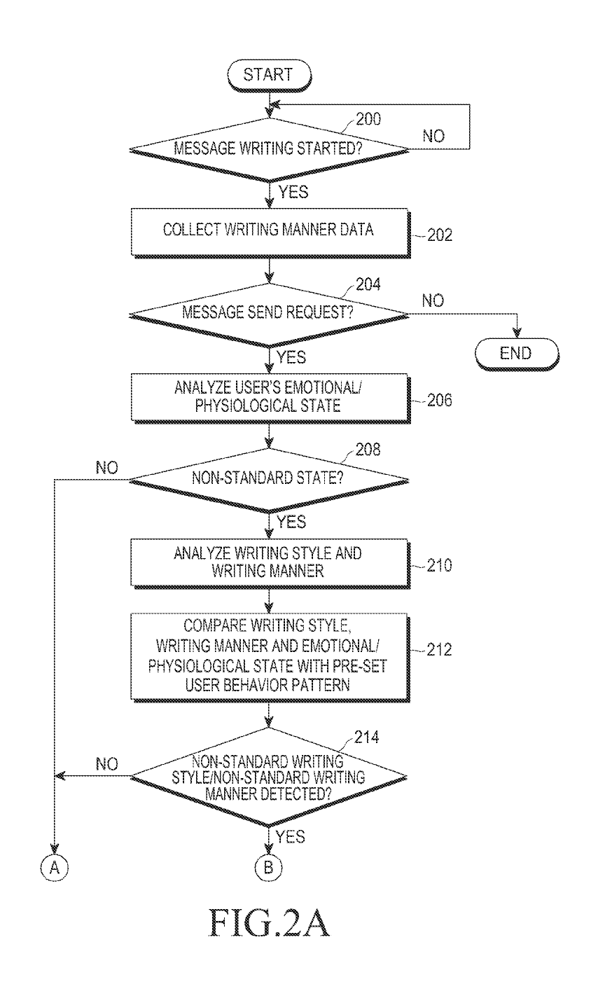

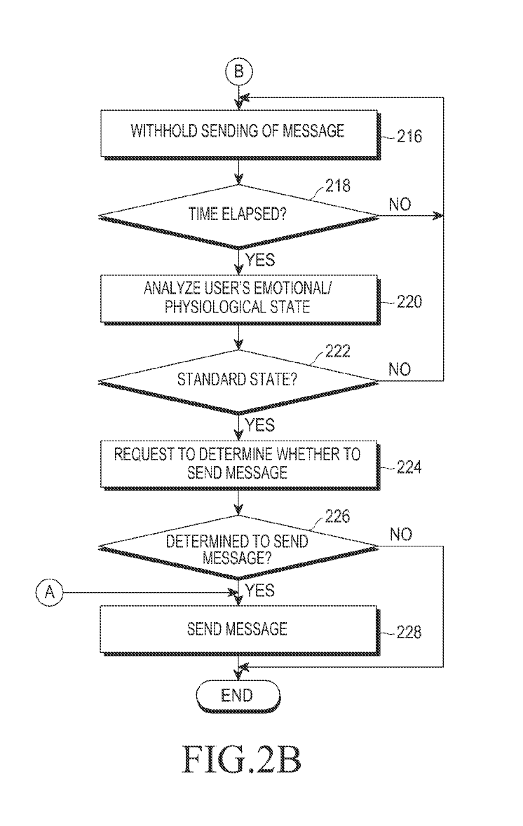

FIGS. 2A and 2B are flowcharts illustrating a method for controlling messaging according to an embodiment of the present invention.

Referring to FIGS. 2A and 2B, if a user starts writing a message on the user interface 102 in step 200, then the controller 100 collects writing manner data generated based on the user's message writing in step 202.

Thereafter, if the user requests to send the message on the user interface 102 in step 204, the controller 100 analyzes a user's emotional/physiological state from the signal received from the input device 104 in step 206, and determines if the user's emotional/physiological state corresponds to a non-standard state in step 208.

If the user's emotional/physiological state does not correspond to the non-standard state, the controller 100 sends the message through the communication unit 110 in step 228.

However, if the user's emotional/physiological state corresponds to the non-standard state, in step 210, the controller 100 analyzes the writing style for content of the message (e.g., texts in the message), and analyzes the writing manner from the writing manner data collected in step 202.

In step 212, the controller 100 compares the writing style, the writing manner and the emotional/physiological state with the pre-set user behavior pattern stored in the DB 108. In step 214, the controller 100 determines whether a non-standard writing style and/or a non-standard writing manner are detected.

If the non-standard writing style and/or a non-standard writing manner are not detected, the controller 100 sends the message through the communication unit 110 in step 228. However, if the non-standard writing style and/or a non-standard writing manner are detected, the controller 100 withholds sending of the message in step 216.

After a lapse of a predetermined time in step 218, the controller 100 analyzes the user's emotional/physiological state from the signal received from the input device 104 in step 220, and determines whether the user's emotional/physiological state has changed to the standard state in step 222.

If the user's emotional/physiological state has changed to the standard state in step 222, the controller 100 requests the user to determine whether to send the message, on the user interface 102 in step 224. For example, requesting the user to determine whether to send the message may be achieved by displaying a phrase asking the user whether they would still like to send the message, on a screen of the user interface 102.

Upon receiving a response indicating an intention to send the message from the user in step 226, the controller 100 sends the message through the communication unit 110 in step 228.

Upon failure to receive a response indicating an intention to send the message from the user in step 226, the controller 100 ends the process.

FIG. 3 is a flowchart illustrating a method for learning a user behavior pattern according to an embodiment of the present invention.

The user behavior pattern learning process illustrated in FIG. 3 may be pre-set to be performed by the controller 100 when the user writes messages in a normal state for user behavior pattern learning. For example, the user behavior pattern learning process may be performed when the user activates a learning mode on a menu of the mobile device, and then writes messages. Alternatively, the user behavior pattern learning process may be pre-set to be automatically performed by the controller 100 when the user writes messages.

Referring to FIG. 3, if the user starts writing a message on the user interface 102 in step 300, in steps 302 and 304, the controller 100 registers a writing manner analyzed based on the user's message writing in the DB 108, until the user stops message writing.

If the user stops message writing in step 304, the controller 100 registers a writing style for content of the message (e.g., texts in the message) in the DB 108 by performing text mining in step 306. In step 308, the controller 100 analyzes a user's emotional/physiological state from the signal received from the input device 104.

In step 310, the controller 100 associates the registered writing style and writing manner with the analyzed user emotional/physiological state in the DB 108. In step 312, the controller 100 sets a user behavior pattern by running a learning process on the data stored in the DB 108. The data stored in the DB 108 may refer to data of the user behavior pattern that is learned based on the previous message writing and stored in the DB 108, and data that is associated in the DB 108 based on the current message writing.

For example, the learning process may be performed based on a common learning process such as decision tree-based learning and an M5 algorithm. An example of decision tree-based learning is described in “Classification and Regression Trees” written by Breiman, Leo et al., and published by Wadsworth & Brooks/Cole Advanced Books & Software in 1984. The M5 algorithm is described in “Learning with Continuous Classes,” written by Quinlan J. R., and published by Basser Department of Computer Science, University of Sydney.

When the emotional/physiological state of the mobile device user corresponds to the standard state of mind, the user behavior pattern associated with the user's unique standard writing style and standard writing manner is pre-set in the DB 108, and used in step 212, as illustrated in FIG. 2A.

As is apparent from the foregoing description, embodiments of the present invention control messaging based on an analysis of message content and user behavior, making it possible to control sending of messages adaptively and intelligently depending on a user's state of mind.

In addition, the above-described embodiments of the present invention control messaging by comparing a user behavior pattern with a pre-set standard user behavior pattern, increasing the possibility of preventing regrettable-messaging and decreasing the false prevention.

Further, the above-described embodiments of the present invention allow a personal mobile device to learn and set its a unique user behavior pattern, and use it in controlling messaging, thereby making it possible to control sending of messages more adaptively and intelligently depending on the user's state.

Upon detecting a non-standard writing style and/or a non-standard writing manner, a mobile device in accordance with the above-described embodiments of the present invention may withhold the sending of message, and when the user's emotional and/or physiological state has changed to the standard state, the mobile device may send the message, upon receiving a response indicating an intention to send the message from the user.

Although FIGS. 2A and 2B illustrate the mobile device analyzing the user's emotional/physiological state and determining whether it corresponds to a non-standard state in steps 206 and 208, before analyzing the writing style and the writing manner, steps 206 and 208 may be omitted in the actual application of the present invention. That is, the mobile device may determine whether to send the message depending on whether a non-standard writing style and/or a non-standard writing manner are detected or not, regardless of whether the user's emotional/physiological state corresponds to the non-standard state. In this case, once the non-standard writing style and/or the non-standard writing manner are detected, the mobile device withholds the sending of the message, still making it possible to increase the possibility of preventing ‘regrettable messaging and decreasing the false prevention, even though it has slightly lower performance, compared to controlling sending of the message depending even on the user's emotional/physiological state.

For similar reasons, in actual application of the present invention, a mobile device may control sending of messages by detecting any one of the non-standard writing style and the non-standard writing manner, instead of detecting both of the non-standard writing style and the non-standard writing manner.

In actual application of the present invention as illustrated in FIGS. 2A and 2B, steps 218 to 226 may also be omitted. That is, the motile device may be set not to send the withheld message. In this case, though the performance of reducing the false prevention may be slightly reduced, the mobile device may still increase the possibility of preventing regrettable messaging and decrease the false prevention, because it controls messaging based on a user behavior pattern.

In addition, the control based on the analysis of message content and user behavior may be applied even in implementation of various other applications other than the application of controlling messaging. For example, the control may be applied even in implementation of an application that notifies abnormality to a predetermined target such as parents of the mobile device's user, when behavior of the mobile device's user is different from usual.

The above-described embodiments of the present invention may also be implemented in hardware, software or a combination of hardware and software. The software may be stored, for example, in volatile/nonvolatile storage devices such as Read Only Memory (ROM) and Random Access Memory (RAM) no matter whether they are erasable or re-writable, or in machine-readable storage media which are optically or magnetically recordable, such as Compact Disc (CD), Digital Versatile Disc (DVD), magnetic disc, and magnetic tapes. Therefore, the present invention may include a program including codes for implementing the apparatus and method defined in the appended claims of the specification, and machine (e.g., computer)-readable storage media storing the program. In addition, the program may be electronically transferred through any media such as communication signals transmitted by wire/wireless connections, and their equivalents.

The mobile device of the present invention may download a program (e.g., application) for controlling sending of messages from a remote program provisioning device (e.g., program server), or install the program in it, and may run the downloaded/installed program, thereby making it possible to control sending of messages. That is, if installed in a mobile device, a program for control sending of messages may run in the mobile device, making it possible to control sending of messages. The program server transmits the program to the mobile device automatically or in response to a transmission request for the program from the mobile device.

Additionally, the program server may determine whether the mobile device has subscribed to the service, and may authenticate a user of the mobile device, and may check payment information of the mobile device. The program server may include a communication unit for performing wire/wireless communication with the mobile device, a storage medium for storing the program, and a controller for transmitting the program to the mobile device through the communication unit. The storage medium may be located either inside or outside of the program server.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method for controlling messaging in a mobile device, the method comprising:
receiving a send request for a message from a user;
analyzing a writing style of content of the message;
comparing the writing style with a user behavior pattern that is pre-set for a standard writing style of the user to determine whether a non-standard writing style is detected; and
withholding sending the message, upon detecting the non-standard writing style.

2. The method of claim 1, further comprising:
analyzing an emotional or physiological state of the user, before analyzing the writing style;
determining whether the emotional or physiological state of the user corresponds to a non-standard state of mind; and
analyzing the writing style, when the emotional or physiological state of the user corresponds to the non-standard state of mind.

3. The method of claim 2, further comprising:
determining whether the emotional or physiological state of the user has changed to a standard state of mind, upon a lapse of a predetermined time, after withholding the sending of the message;
requesting the user to determine whether to send the message, when the emotional or physiological state of the user has changed to the standard state of mind; and
sending the message, upon receiving a response indicating an intention to send the message.

4. The method of claim 2, further comprising setting the user behavior pattern by running a learning process that associates the writing style of the user with the emotional or physiological state of the user, when the user writes the message.

5. A method for controlling messaging in a mobile device, the method comprising:
collecting writing manner data associated with a user writing a message;
receiving a send request for the message from the user;
analyzing a writing manner from the writing manner data;
comparing the writing manner with a user behavior pattern that is pre-set for a standard writing manner of the user to determine whether a non-standard writing manner is detected; and
withholding sending of the message, upon detecting the non-standard writing manner.

6. The method of claim 5, further comprising:
analyzing an emotional or physiological state of the user, before analyzing the writing manner;
determining whether the emotional or physiological state of the user corresponds to a non-standard state of mind; and
analyzing the writing manner, when the emotional or physiological state of the user corresponds to the non-standard state of mind.

7. The method of claim 6, further comprising:
determining whether the emotional or physiological state of the user has changed to a standard state of mind, upon a lapse of a predetermined time, after withholding the sending of the message;
requesting the user to determine whether to send the message, when the emotional or physiological state of the user has changed to the standard state of mind; and
sending the message, upon receiving a response indicating an intention to send the message.

8. The method of claim 6, further comprising setting the user behavior pattern by running a learning process that associates the writing manner of the user with the emotional or physiological state of the user, when the user writes the message.

9. A method for controlling messaging in a mobile device, the method comprising:
collecting writing manner data associated with a user writing a message;
receiving a send request for the message from the user;
analyzing a writing style of content of the message;
analyzing a writing manner from the writing manner data;
comparing the writing style and the writing manner with a user behavior pattern pre-set for a standard writing style and a standard writing manner of the user to determine whether a non-standard writing style or a non-standard writing manner is detected; and
withholding sending of the message, upon detecting the non-standard writing style or the non-standard writing manner.

10. The method of claim 9, further comprising:
analyzing an emotional or physiological state of the user, before analyzing the writing style and the writing manner;
determining whether the emotional or physiological state of the user corresponds to a non-standard state of mind; and
analyzing the writing style and the writing manner, when the emotional or physiological state of the user corresponds to the non-standard state of mind.

11. The method of claim 10, further comprising:
determining whether the emotional or physiological state of the user has changed to a standard state of mind, upon a lapse of a predetermined time, after withholding the sending of the message;
requesting the user to determine whether to send the message, when the emotional or physiological state of the user has changed to the standard state of mind; and
sending the message, upon receiving a response indicating an intention to send the message.

12. The method of claim 10, further comprising setting the user behavior pattern by running a learning process that associates the writing style and the writing manner of the user with the emotional or physiological state of the user, when the user writes the message.

13. A mobile device that controls messaging, the mobile device comprising:
a user interface;
a database that stores a user behavior pattern that is pre-set for a standard writing style of a user; and
a controller that receives a send request for a message from the user through the user interface, analyzes a writing style of content of the message, compares the writing style with the user behavior pattern, and withholds sending the message, upon detecting a non-standard writing style.

14. The mobile device of claim 13, further comprising an input device that provides a signal indicating an emotional or physiological state of the user, to the controller,
wherein before analyzing the writing style, the controller analyzes the emotional or physiological state of the user from the signal provided from the input device, and analyzes the writing style, when the emotional or physiological state of the user corresponds to a non-standard state of mind.

15. The mobile device of claim 14, wherein the controller checks the emotional or physiological state of the user upon a lapse of a predetermined time, after it withholds sending the message, requests the user to determine whether to send the message on the user interface, when the emotional or physiological state of the user has changed to a standard state of mind, and sends the message, upon receiving a response indicating an intention to send the message.

16. The mobile device of claim 14, wherein the controller sets the user behavior pattern by running a learning process that associates the writing style of the user with the emotional or physiological state of the user, when the user writes the message.

17. A mobile device that controls messaging, the mobile device comprising:
a user interface;
a database that stores a user behavior pattern that is pre-set for a standard writing manner of a user; and
a controller that detects the user writing a message on the user interface, collects writing manner data associated with the user writing the message, and upon receiving a send request for the message from the user, analyzes a writing manner from the writing manner data, compares the writing manner with the user behavior pattern, and withholds sending the message, upon detecting a non-standard writing manner.

18. The mobile device of claim 17, further comprising an input device that provides a signal indicating an emotional or physiological state of the user, to the controller,
wherein before analyzing the writing manner, the controller analyzes the emotional or physiological state of the user from the signal provided from the input device, and analyzes the writing manner, when the emotional or physiological state of the user corresponds to a non-standard state of mind.

19. The mobile device of claim 18, wherein the controller checks the emotional or physiological state of the user upon a lapse of a predetermined time, after it withholds sending the message, requests the user to determine whether to send the message on the user interface, when the emotional or physiological state of the user has changed to a standard state of mind, and sends the message, upon receiving a response indicating an intention to send the message.

20. The mobile device of claim 18, wherein the controller sets the user behavior pattern by running a learning process that associates the writing manner of the user with the emotional or physiological state of the user, when the user writes the message.

21. A mobile device that controls messaging, the mobile device comprising:
a user interface;
a database that stores a user behavior pattern that is pre-set for a standard writing style and a standard writing manner of a user; and
a controller that detects when the user starts writing a message on the user interface, collects writing manner data associated with the message writing, and upon receiving a send request for the message from the user, analyzes a writing style of content of the message, analyzes a writing manner from the writing manner data, compares the writing style and the writing manner with the user behavior pattern, and withholds sending the message, upon detecting a non-standard writing style or a non-standard writing manner.

22. The mobile device of claim 21, further comprising an input device that provides a signal indicating an emotional or physiological state of the user, to the controller,
wherein before analyzing the writing style and the writing manner, the controller analyzes the emotional or physiological state of the user from the signal provided from the input device, and analyzes the writing style and the writing manner, when the emotional or physiological state of the user corresponds to a non-standard state of mind.

23. The mobile device of claim 22, wherein the controller checks the emotional or physiological state of the user upon a lapse of a predetermined time, after it withholds sending the message, requests the user to determine whether to send the message on the user interface, when the emotional or physiological state of the user has changed to a standard state of mind, and sends the message, upon receiving a response indicating an intention to send the message.

24. The mobile device of claim 22, wherein the controller sets the user behavior pattern by running a learning process that associates the writing style and the writing manner of the user with the emotional or physiological state of the user, when the user writes the message.
